(19) United States
(12) Patent Application Publication
(10) Pub. No.: US 2011/0097223 A1
(43) Pub. Date: Apr. 28, 2011

(54) OIL FILTER FOR DOWNHOLE MOTOR

(75) Inventors: Stanislav Nikolaevich Verichev, Nizhny Novgorod (RU); Jacques Orban, Moscow (RU); Evgeny Mikhailovich Sviridov, Moscow (RU)

(73) Assignee: Schlumberger Technology Corporation, Sugar Land, TX (US)

(21) Appl. No.: 12/864,688

(22) PCT Filed: Jan. 31, 2008
(86) PCT No.: PCT/RU08/00050

§ 371 Date: Dec. 8, 2010

(51) Int. Cl. F04B 9/02; B01D 29/58; B01D 35/02; B01D 29/52; H02K 5/132

(52) U.S. Cl. 417/374; 210/489; 210/457; 210/347; 210/338; 210/437; 210/323.1; 210/335; 310/87

(57) ABSTRACT

An oil filter for use in an electric motor forming part of a downhole device such as an ESP, comprising a two-part filter including a first part formed from a porous material which acts to filter solid particulate material from the motor oil, and a second part comprising a sorbent for removing aqueous liquids from the motor oil.

### TECHNICAL FIELD

This invention relates to oil filters for use in electric motors for downhole tools. In particular, the invention relates to oil filters for use in the motors of electric submersible pumps of the type used in oil wells.

### BACKGROUND ART

FIG. 1 shows an ESP of the type to which the present invention relates. Such pumps are typically used in oil wells to provide artificial lift where there is insufficient reservoir pressure to produce oil to surface. The pump comprises a motor section 10 including an electric motor, a protector section 12 above the motor which provides an inlet for well fluids, and a pump section 14 including a multi stage pump. A drive shaft (not shown) extends from the motor section through the protector to the pump. Electric power is provided from the surface by means of a cable (not shown).

The motor section comprises an oil-filled housing in which a rotor mounted in the drive shaft and a stator is located. The oil acts to lubricate the moving parts of the motor and to provide electrical insulation between the electrical components.

In use, the oil becomes contaminated due to the build-up of particulate materials arising from physical wear and erosion of the parts of the motor. Filters are provided in the motor housing to filter the particulates from the oil and maintain its lubricating properties.

Many ESP failures arise as a result of arcing in the motor section. This occurs when the insulating properties of the oil break down to the extent that arcing becomes possible. Breakdown of the insulating properties typically occurs by contamination with aqueous fluids, particularly acids, that enter the motor housing from the well through rotating seals around the drive shaft where it connects to the pump section. However, current oil filters are not capable of removing such contaminants since they easily pass through the physical filters.

It is an object of the invention to provide a filter that can deal with contamination by aqueous fluids as well as particulate materials.

### DISCLOSURE OF THE INVENTION

One aspect of the invention provides an oil filter for use in an electric motor forming part of a downhole device, comprising a two-part filter including a first part formed from a porous material which acts to filter solid particulate material from the motor oil, and a second part comprising a sorbent for removing aqueous liquids from the motor oil.

Preferably the filter comprises a body defining a central bore through which a drive shaft of the motor can extend. The body can comprise multiple filter blocks joined together to define the central bore.

It is particularly preferred that the body comprises a chamber formed from a porous material defining the first part of the filter, the sorbent being contained within the chamber. One preferred form of chamber comprises a U-shaped section with an angled cover. In this case, the porous material forming the U-shaped section can have a smaller pore size that that forming the angled cover.

Preferably, the porous material comprises porous metal. The sorbent can comprise silica gel, activated carbon, whitening clay, zeolite, alumina oxide or mixtures thereof.

A second aspect of the invention provides a motor for a downhole device comprising a motor housing containing a stator fixed to the housing, a rotor mounted on a drive shaft in the housing, and an oil filter according to the first aspect of the invention mounted in the housing and preferably around the drive shaft.

Preferably, the motor comprises multiple filters in the housing, for example oil filters can be mounted above both above and below the rotor and stator.

The motor can further comprise a washer located around the drive shaft above the oil filter that extends radially outwardly from the drive shaft so that flow is directed through the filter rather than between the drive shaft and the filter.

A third aspect of the invention provides an ESP comprising a motor according to the second aspect of the invention, wherein the drive shaft is connected to a shaft in a pump section.

The motor is typically positioned below the pump section. A protector section can be positioned between the motor and the pump section. In this case, the upper filter can be located in the protector section.

Further aspects of the invention will be apparent from the following detailed description.

### BRIEF DESCRIPTION OF THE DRAWINGS

FIG. 1 shows a schematic view of an ESP;

FIG. 2 shows a cross section through a filter according to a first embodiment of the invention;

FIG. 3 shows a cross section through a second embodiment of the invention;

FIG. 4 shows a modification of embodiment of FIG. 3;

FIGS. 5 and 6 show a third embodiment of the invention; and

FIG. 7 shows a further embodiment of the filter according to the invention.

### MODE(S) FOR CARRYING OUT THE INVENTION

Most ESP failures are caused by a motor failure. In many cases, this happens because of arcing in the motor due to decrease in arcing voltage of isolation oil that fills the motor chamber and lies between rotor and stator. Such decrease in arcing voltage is caused by water penetration, corrosion (which leads to the increase in acid number/pH) and the appearance of conductive particulate material due to wear and scaling. This invention provides techniques for effectively continuous in-situ oil purification in such a way that water, acids and particulates can be removed continuously by means of filtering and absorption so as to maintain oil insulation properties at the desired level. Such techniques can be used not only for submersible electrical systems such as ESP's but for any other electric devices that use insulating oil and can experience the problems discussed above.

In previous ESPs, the only filtering system was a metal filter with relatively large pores for removing particulates. This filter is placed in the bottom of the motor section. While such a filter solves the problem of oil contamination by particulates, it is totally ineffective with respect to water contaminations and acidising. Since water often enters the motor from the above (from the protector section), even the placement of such a filter is not correct. In one aspect of the invention, the filter can be placed below the phase seal between the protector and motor section through which the motor drive shaft passes. Such placement, ensures that water leakage can be successfully captured by this system before it enters the motor itself and causes problems.

This invention is based on the use of two mechanisms: filtering and absorption. Filtering can typically be achieved with the help of any porous filter such as metal filter, ceramic filter etc. The part responsible for absorption typically comprises a silica gel (however, for different systems, other sorbents such as zeolite, activated carbon etc. can be also used). The choice of a sorbent depends on exploitation conditions and type of typical contaminations.

There are effectively three factors that affect oil insulation properties: water, acids and conductive/magnetic particulates. The filter according to the invention includes two parts: porous filter used to remove mechanical conductive particulates (metal filter, ceramic filter etc.) and a sorbent used to remove water and acids (silica gel etc). The filter may be constructed in various ways, for example:

Two coupled chambers providing to the porous filter and sorbent, respectively.

The sorbent can be placed inside a porous chamber (such as metal, ceramics etc.) ensuring that it can stand high external pressures.

Each sorbent particle can be covered by porous material and the particles placed afterwards in a wise mesh structure (e.g. a metal net). Further examples will be discussed below.

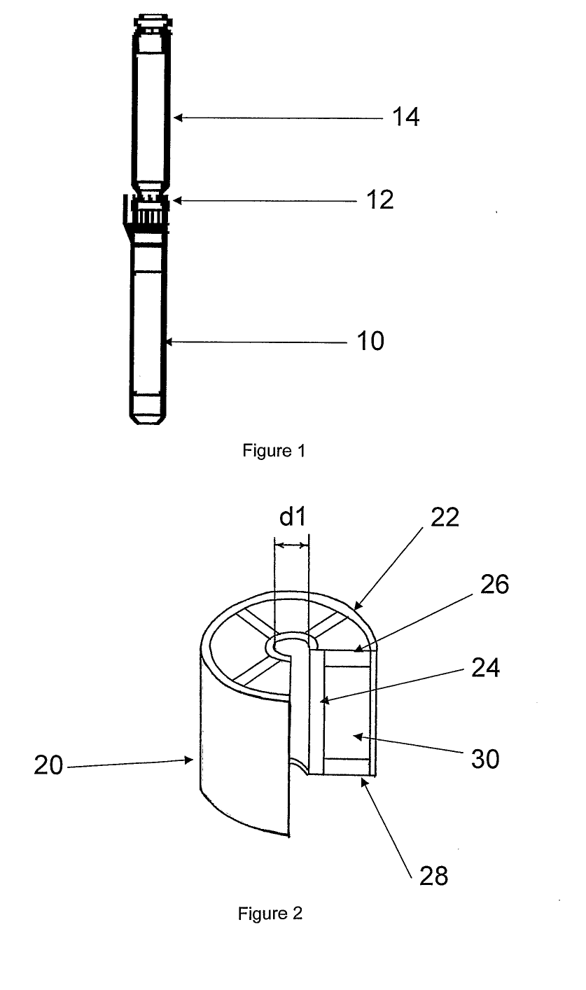

Since oil is present between the moving and immovable parts (e.g. rotor and stator, shaft and housing etc.), the filter can be installed in such way that oil will pass through it naturally because of the flow caused by the rotating parts. FIG. 2 shows one embodiment of a possible filter structure comprising a housing 20 formed from a hollow steel cylinder that is provided with a cover 22. A porous cylinder 24 provides a central bore around which porous top and bottom discs 26, 28 are provided such that the housing 20, cylinder 24 and discs 26, 28 form a toroidal chamber in which silica gel sorbent 30 is located. The inside diameter d1 of the cylinder 24 is slightly large than the outside diameter of the motor shaft (not shown) so that the filter can be positioned around the shaft.

One modification to this approach can be the addition of small blades attached to the shaft that enhance the flow of oil through this filter in radial direction when the shaft is rotating. The filter can be installed as integrated system (e.g. as a part of the ESP protector), as a bypass system connected to the main electric system (motor) using tubing, direct coupling etc. The volume of sorbent can be 10% of the total oil volume, for example.

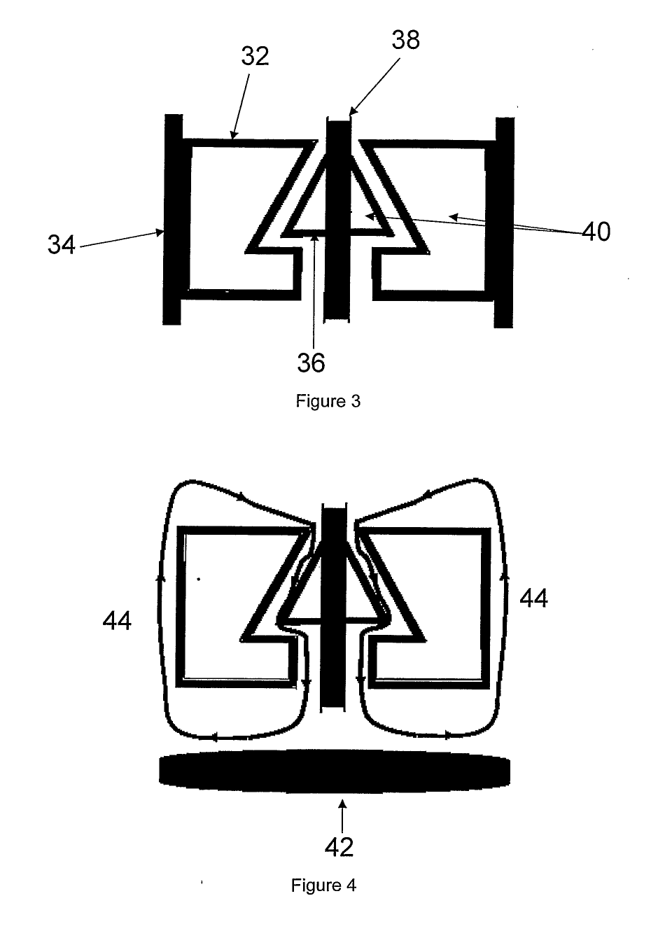

Another embodiment of the invention is shown in FIG. 3 in which the filter housing includes two sections: one immovable 32, attached to the pump housing 34; and one rotating part 36 attached to the drive shaft 38. both sections are formed from porous metal and contain silica gel sorbent 40. The construction of the two sections is such that a flow channel is formed between the two sections has with a profile that ensures that fluid always passes across the filter even when the motor is stopped.

FIG. 4 shows a modification of the embodiment of FIG. 3 in which the filter is placed above a thrust bearing 42 ensuring the backflow of oil across the filter as indicated by the arrows 44. A small flow channel can be provided between the filter outer wall and pump housing. Such a filter may be installed below the lower rotary seal at the bottom of the motor etc.

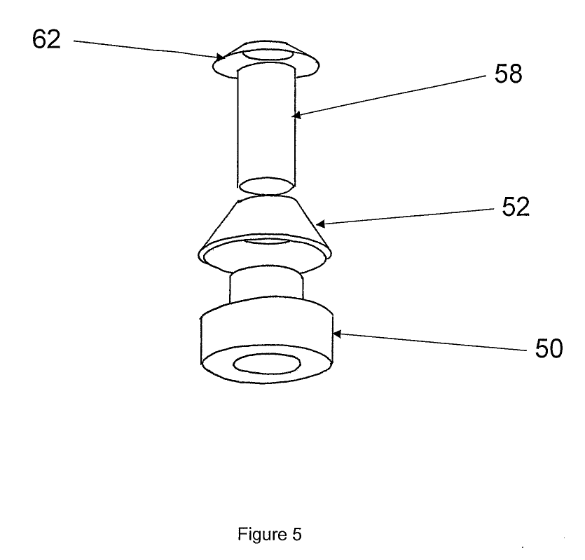

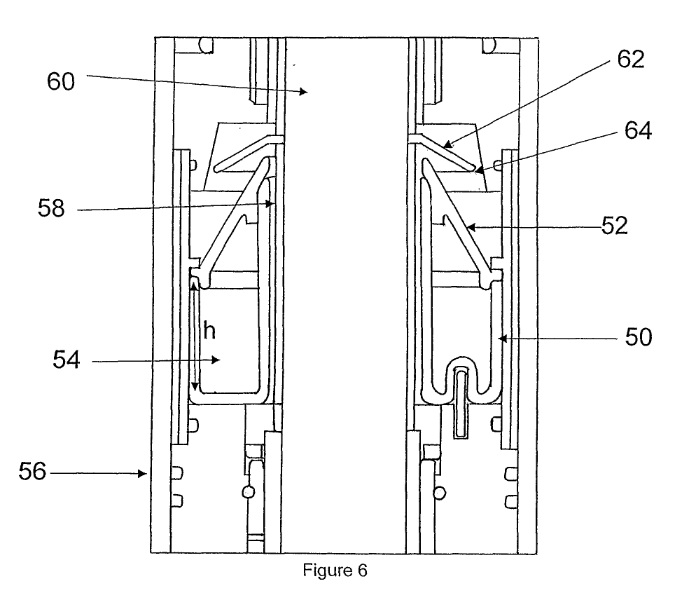

Another, preferred, embodiment of the invention is shown in FIGS. 5 and 6. In this case, the filter body is formed in two parts comprising a U-shaped channel section 50 and a circular angled cover 52 that fits on the section 50 to define the filter chamber 54. The section 50 and cover 52 are formed from porous metal and silica gel sorbent fills the chamber 54. The filter body is attached to the motor housing 56 and a sleeve 58 is provided around the motor shaft 60 where it passes through the bore in the middle of the filter body. The sleeve 60 allows parts of the pump above and below the filter to be held in compression on the shaft 60.

The porous metal forming the U-shaped section 50 can have a smaller pore size than that forming the angled cover 52. In this way filtering of particulates can be optimised by arranging the cover 52 to trap the larger particulates while allowing smaller particulates into the chamber 54 where they are filtered by the smaller pores of the U-shaped section 50. Filtering by the angled cover 52 can also be optimised by adjusting the relative axial heights h of the inner and outer arms of the U-shaped section 50 so as to provide an angled cover 52 of an appropriate surface area.

A downwardly-angled washer 62 is mounted around the shaft 60 above the filter body, the outer periphery 64 of the washer 62 extending well over the angled cover 52.

In use, oil in the motor housing will circulate through the filter body, the section 50 and cover 52 acting to remove particulates and the silica gel absorbing water and aqueous liquids. Particulates and liquid droplets that fall down into the housing from above (e.g. from the pump section or the protector section) are defected by the washer so as to fall on the cover and be filtered rather than pass between the filter and the shaft.

It is particularly preferred that multiple filters are placed in the housing, for example one such filter can be positioned at the top of the motor (or in the bottom of the protector section) and another at the bottom of the motor section.

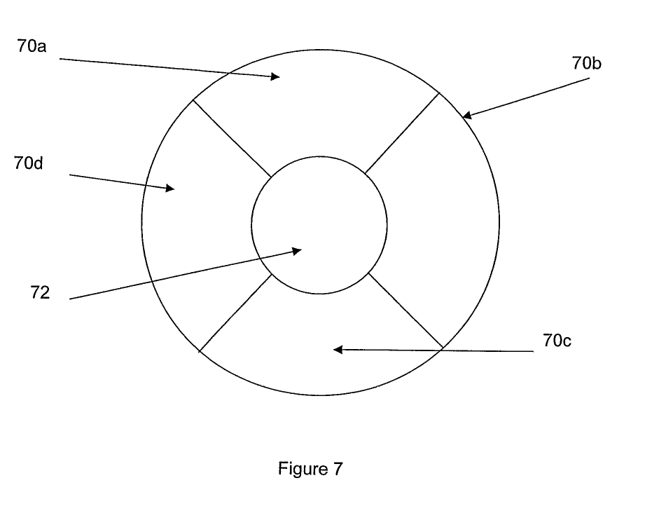

The filter itself can be made from multiple filter blocks joined together to define the central bore. FIG. 7 shows one such example in which four filter blocks 70a-70d are arranged to define a central bore 72 though which the shaft can extend. Other, similar arrangements with different numbers of block can also be used.

Other changes within the scope of the invention will be apparent.

1. An oil filter for use in an electric motor forming part of a downhole device, comprising a two-part filter including a first part formed from a porous material which acts to filter solid particulate material from the motor oil and a second part comprising a sorbent for removing aqueous liquids from the motor oil.

2. An oil filter as claimed in claim 1, comprising a filter body defining a central bore through which a drive shaft of the motor can extend.

3. A oil filter as claimed in claim 2, wherein the body comprises multiple filter blocks joined together so as to define the central bore.

4. An oil filter as claimed in claim 2, wherein the body comprises a chamber formed from the porous material defining the first part of the filter, the sorbent being contained in the chamber.

5. An oil filter as claimed in claim 4, wherein the chamber comprises a U-shaped section with an angled cover.

6. An oil filter as claimed in claim 5, the porous material forming the U-shaped section has a smaller pore size than that forming the angled cover.

7. An oil filter as claimed in claim 1, wherein the porous material comprises porous metal.

8. An oil filter as claimed in claim 1, wherein the sorbent comprises silica gel, activated carbon, whitening clay, zeolite, alumina oxide or mixtures thereof.

9. A motor for a downhole device comprising a motor housing containing a stator fixed to the housing, a rotor mounted on a drive shaft in the housing, and an oil filter as claimed in any preceding claim mounted in the housing.

10. A motor as claimed in claim 9 comprising multiple filters mounted in the housing.

11. A motor as claimed in claim 10, comprising oil filters above and below the rotor and stator.

12. A motor as claimed in claim 9, further comprising a washer located around the drive shaft above the oil filter that extends radially outwardly from the drive shaft so that flow is directed through the filter rather than between the drive shaft and the filter.

13. An electric submersible pump comprising a motor as claimed in any of claim 9, wherein the drive shaft is connected to a shaft in a pump section.

14. A pump as claimed in claim 13, wherein the motor is positioned below the pump section.

15. A pump as claimed in claim 13, wherein a protector section is positioned between the motor and the pump section.

16. An electric submersible pump comprising a motor as claimed in claim 9, wherein the drive shaft is connected to a shaft in a pump section.

17. An electric submersible pump comprising a motor as claimed in claim 7, wherein the drive shaft is connected to a shaft in a pump section.

18. A pump as claimed in claim 14, wherein the protector section is positioned between the motor and the pump section.

19. An oil filter as claimed in claim 3, wherein the body comprises a chamber formed from the porous material defining the first part of the filter, the sorbent being contained in the chamber.

20. A motor as claimed in claim 10, further comprising a washer located around the drive shaft above the oil filter that extends radially outwardly from the drive shaft so that flow is directed through the filter rather than between the drive shaft and the filter.
